(19) United States
(12) Patent Application Publication
(10) Pub. No.: US 2013/0143175 A1
(43) Pub. Date: Jun. 6, 2013

(54) ILLUMINATED MICRO-MOTOR HAND PIECE IN A VETERINARY DENTAL DEVICE

(71) Applicants: Charles F. Betyeman, Milton, DE (US); Dennis Karol, Rehoboth Beach, DE (US)

(72) Inventors: Charles F. Betyeman, Milton, DE (US); Dennis Karol, Rehoboth Beach, DE (US)

(21) Appl. No.: 13/692,906

(22) Filed: Dec. 3, 2012

Related U.S. Application Data
(60) Provisional application No. 61/566,431, filed on Dec. 2, 2011.

(51) Int. Cl. A61D 5/00

(52) U.S. Cl. CPC A61D 5/00
USPC 433/1

(57) ABSTRACT

A micro-motor hand piece solves the problem of a lack of directly focused light in a patient's oral cavity when polishing a patient's teeth or performing dentistry. The source of illumination is built directly into the nose of the micro-motor hand piece to flood the area around the working tip of the micro-motor hand piece with light. The light is automatically focused in the area in which the Veterinarian or Technician is working, without casting any shadows in the area undergoing the procedure. The light can be from, for example, three light emitting diodes (LEDs), or some other light source, such as a fiber optic light source, incorporated directly into the nose of the micro motor hand piece.

### CROSS-REFERENCE TO RELATED APPLICATION

This application claims the benefit of priority of U.S. provisional application number 61/566,431, filed Dec. 2, 2011, the contents of which are herein incorporated by reference.

### BACKGROUND OF THE INVENTION

The present invention relates to veterinary devices and, more particularly, to an illuminated micro-motor hand piece in a veterinary dental device.

Conventional micro-motor hand pieces must rely primarily on exam room overhead lights or a separate light source must be attached to the hand piece. In the case of overhead lights, the light source is obscured by the Veterinarian or Technician's hands working within the oral cavity with the hand piece. This casts shadows and does not direct a focused beam of light in the area to be worked. The Veterinarian or Technician must therefore continually adjust the position of the light or the patient.

Light source attachments can be added to micro-motor hand pieces. However, using a light source attachment can be very bulky and difficult to maneuver inside the oral cavity. This slows down the dental procedure and may require re-positioning of the patient to get to the specific area to be worked within the oral cavity.

As can be seen, there is a need for a simple, convenient and easy to use light source for a micro-motor hand piece.

### SUMMARY OF THE INVENTION

In one aspect of the present invention, a micro-motor hand piece comprises a body; a motor in the body; a nose on one end of the body; a plurality of lights disposed in the nose, the plurality of lights adapted to illuminate forward of the nose; and a device attachment interconnected to the nose and operably driven by the motor.

In another aspect of the present invention, a micro-motor hand piece comprises a body; a motor in the body; a nose on one end of the body; a plurality of light slots formed in the nose; a plurality of lights disposed in the light slots of the nose, the plurality of lights adapted to illuminate forward of the nose; a light controller disposed in the body, the light controller regulating the power to the plurality of lights to provide a stable light output when the motor is turned on, regardless of motor speed and motor direction; and a device attachment interconnected to the nose and operably driven by the motor.

These and other features, aspects and advantages of the present invention will become better understood with reference to the following drawings, description and claims.

### BRIEF DESCRIPTION OF THE DRAWINGS

FIG. 1 is a perspective view of a micro-motor hand piece, having a plurality of lighting elements, according to an exemplary embodiment of the present invention;

FIG. 2 is a front view of the micro-motor hand piece of FIG. 1;

FIG. 3 is a detailed perspective view of the nose end and device attachment on the micro-motor hand piece of FIG. 1;

FIG. 4 is a side view of the micro-motor hand piece of FIG. 1;

FIG. 5 is a partially exploded perspective view of the micro-motor hand piece of FIG. 1;

FIG. 6 is a fully exploded perspective view of the micro-motor hand piece of FIG. 1; and

FIG. 7 is an electrical schematic diagram showing an exemplary electrical configuration of the micro-motor hand piece of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a micro-motor hand piece that solves the problem of a lack of directly focused light in a patient's oral cavity when polishing a patient's teeth or performing dentistry. The source of illumination is built directly into the nose of the micro-motor hand piece to flood the area around the working tip of the micro-motor hand piece with light. The light is automatically focused in the area in which the Veterinarian or Technician is working, without casting any shadows in the area undergoing the procedure. The light can be from, for example, three light emitting diodes (LEDs), or some other light source, such as a fiber optic light source, incorporated directly into the nose of the micro motor hand piece. Since the light source is mounted directly into the micro-motor hand piece, this solution is more cost efficient for the customer than purchasing a separate external light source to be affixed to the micro-motor hand piece and requiring the purchase of non-conventional, proprietary adapters or prophy angles.

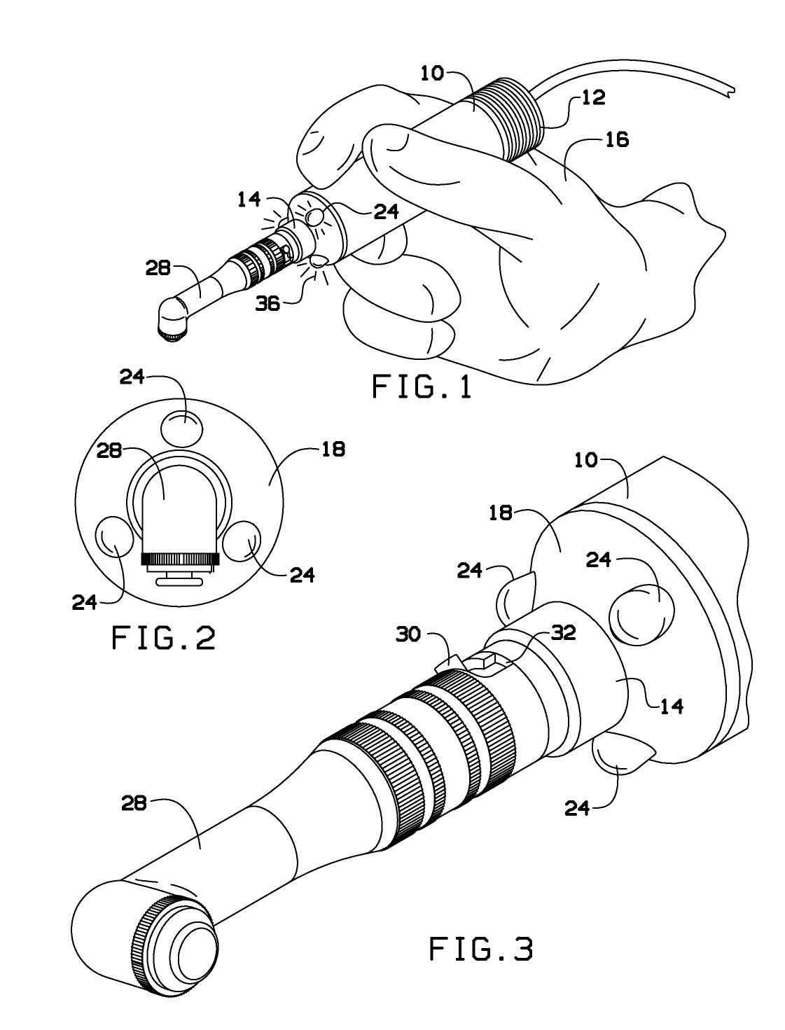

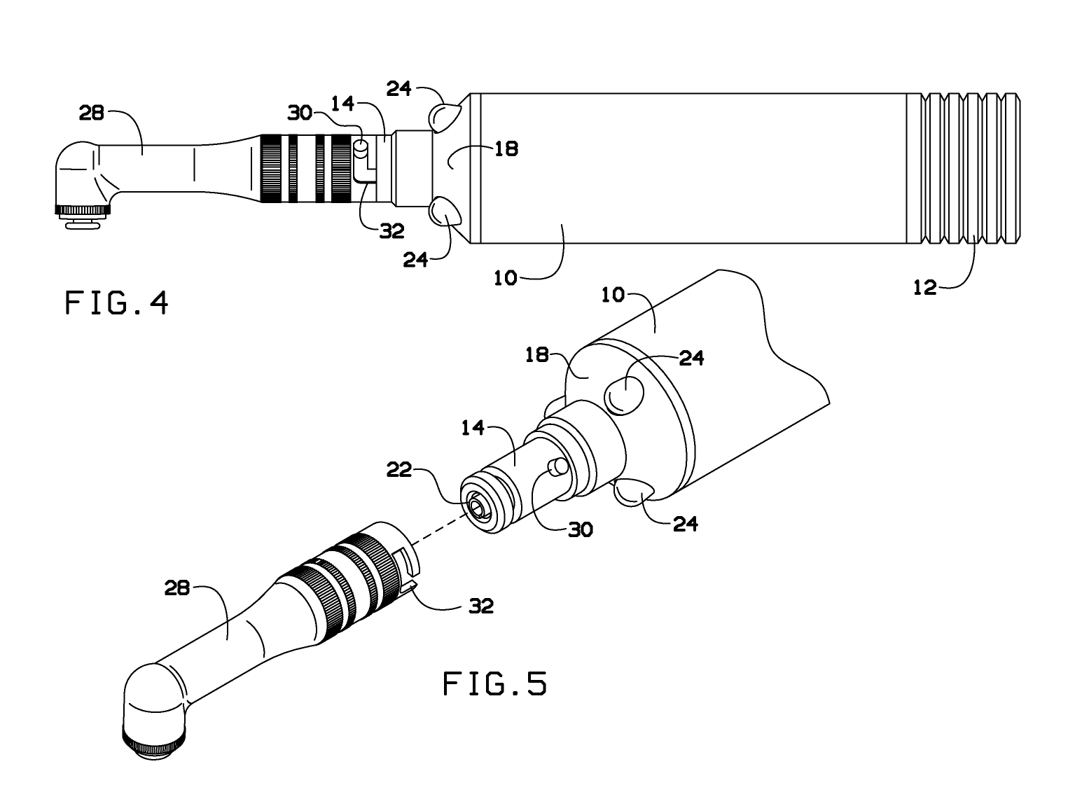

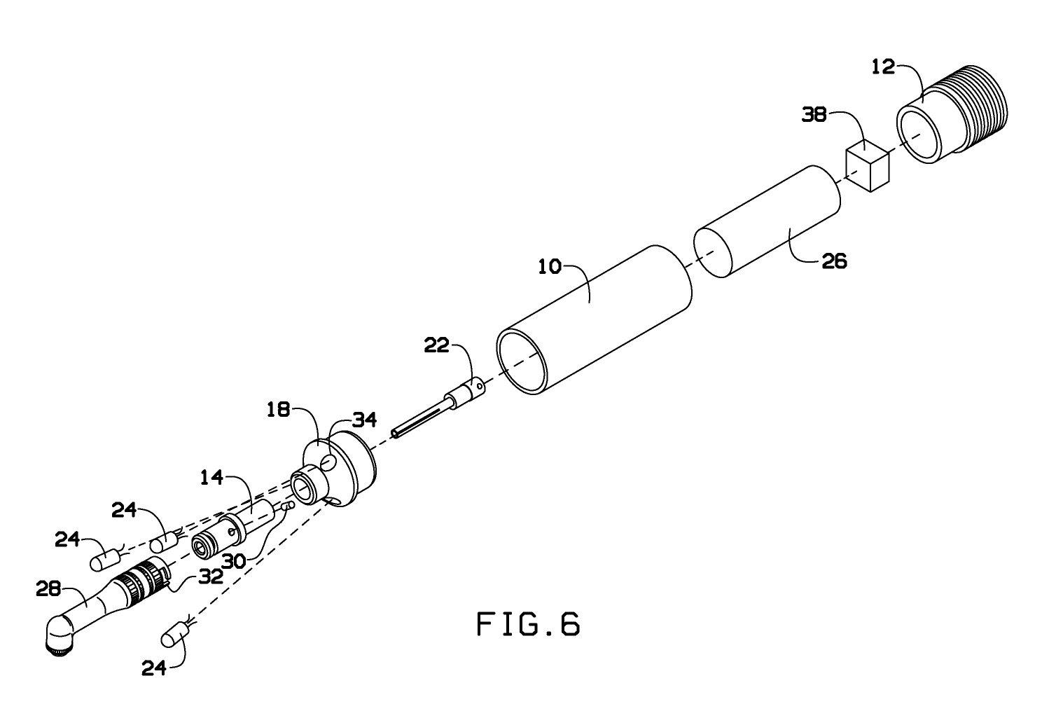

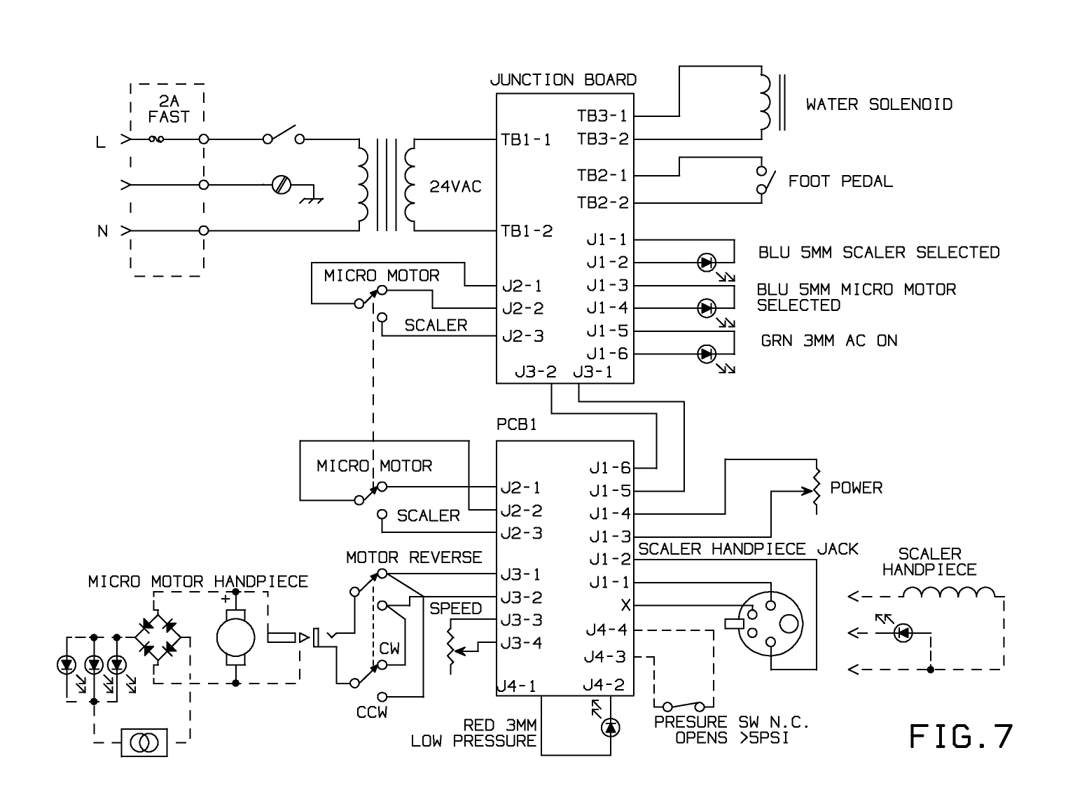

Referring now to FIGS. 1 through 7, a micro-motor hand piece body 10 can include an end cap 12 for plugging in, or otherwise attaching, a control wire. A user 16 can hold onto the body 10 during use of the micro-motor hand piece.

A motor 26 can be disposed inside the body 10. In addition, a light controller 38 for the lights 24 can also be disposed inside the body 10. A drive adaptor 22 can be turned by the motor 26 and extend beyond a nose 18 of the body 10. A motor guide 14 can connect to the nose 18 and receive the drive adaptor 22. One or more pins 30 can be disposed on the motor guide 14. A device attachment 28 can attach to the motor guide 14 and be secured by the pins 30 fitting into one or more slots 32 in the device attachment 28.

The nose 18 can include a plurality of light slots 34. Typically three light slots 34 are disposed about the end of the nose 18. Typically, the light slots 34 are equally spaced about the end of the nose 18. The lights 24 can fit into the light slot 34 and be electrically connected to the light controller 38. The lights 24 can be various types of lights, including incandescent, LED, fiber optic, or the like.

Power for the lights 24 can be obtained from the same power that supplies the motor 26. In a typical embodiment, the lights 24 are connected to turn on and off along with the motor 26. Since the motor 26 is reversible, a bridge rectifier can be used to ensure the polarity of the voltage supplied to the lights 24 is correct. Additionally, since the voltage to the motor 26 is variable, a current regulator integrated circuit can be used to regulate the current available to the lights 24. This ensures that the lights 24 do not vary in brightness as the speed of the motor 26 is increased or decreased.

Since all of the electronics are mounted within the micro-motor hand piece, the “illuminated” hand piece can be used on any dental polishing unit that supplies the same or similar voltages. If required, the hand piece plug can be adapted for use with devices that are not manufactured by the same company.

When the micro-motor hand piece is activated, the incorporated lights 24 (such as high intensity LEDs) are illuminated, allowing Veterinarians and Technicians to have a flooding light aimed exactly in the area in which they are working. Since the light source is directly built into the micro-motor hand piece and generates illumination merely by turning on the unit, no training is necessary for the operator. The Veterinarian or Technician performs the dental procedure that he/she has been trained to do, but now has a clear stream of light illuminating the area in which he/she works.

While described above as a micro-motor hand piece for veterinary dental applications, the present invention can be adapted for use in nearly any low voltage power hand tool. A battery-operated “snap-on” version could be used with non-powered hand tools.

It should be understood, of course, that the foregoing relates to exemplary embodiments of the invention and that modifications may be made without departing from the spirit and scope of the invention as set forth in the following claims.

What is claimed is:

1. A micro-motor hand piece comprising:
a body;
a motor in the body;
a nose on one end of the body;
a plurality of lights disposed in the nose, the plurality of lights adapted to illuminate forward of the nose; and
a device attachment interconnected to the nose and operably driven by the motor.

2. The micro-motor hand piece of claim 1, further comprising a light controller disposed in the body, the light controller regulating the power to the plurality of lights to provide a stable light output when the motor is turned on, regardless of motor speed and motor direction.

3. The micro-motor hand piece of claim 1, wherein the plurality of lights are light emitting diodes (LED).

4. The micro-motor hand piece of claim 1, wherein the plurality of lights are fiber optic lights.

5. The micro-motor hand piece of claim 1, wherein the plurality of lights are incandescent lights.

6. The micro-motor hand piece of claim 1, wherein the plurality of lights are disposed in light slots disposed in the nose.

7. The micro-motor hand piece of claim 1, wherein the plurality of lights includes three lights.

8. The micro-motor hand piece of claim 1, further comprising a drive adaptor driven by the motor.

9. The micro-motor hand piece of claim 8, further comprising a motor guide attached to the nose and receiving the drive adaptor.

10. The micro-motor hand piece of claim 9, further comprising one or more pins on the motor guide, the one or more pins operable to fit into one or more slots of the device attachment to secure the device attachment to the motor guide.

11. A micro-motor hand piece comprising:
a body;
a motor in the body;
a nose on one end of the body;
a plurality of light slots formed in the nose;
a plurality of lights disposed in the light slots of the nose, the plurality of lights adapted to illuminate forward of the nose;
a light controller disposed in the body, the light controller regulating the power to the plurality of lights to provide a stable light output when the motor is turned on, regardless of motor speed and motor direction; and
a device attachment interconnected to the nose and operably driven by the motor.

12. The micro-motor hand piece of claim 11, wherein the plurality of lights are light emitting diodes (LED).

13. The micro-motor hand piece of claim 11, wherein the plurality of lights are fiber optic lights.

14. The micro-motor hand piece of claim 11, wherein the plurality of lights are incandescent lights.

15. The micro-motor hand piece of claim 11, further comprising a drive adaptor driven by the motor.

16. The micro-motor hand piece of claim 15, further comprising a motor guide attached to the nose and receiving the drive adaptor.

17. The micro-motor hand piece of claim 16, further comprising one or more pins on the motor guide, the one or more pins operable to fit into one or more slots of the device attachment to secure the device attachment to the motor guide.
